(19) United States
(12) Patent Application Publication
(10) Pub. No.: US 2011/0133549 A1
(43) Pub. Date: Jun. 9, 2011

(54) MOTOR DRIVE SYSTEM FOR HYBRID VEHICLE AND METHOD FOR CONTROLLING THE SAME

(75) Inventor: Hong Seok Song, Seongnam (KR)

(73) Assignee: HYUNDAI MOTOR COMPANY, Seoul (KR)

(21) Appl. No.: 12/778,425

(22) Filed: May 12, 2010

(30) Foreign Application Priority Data
Dec. 4, 2009 (KR) 10-2009-0119489

(51) Int. Cl. B60L 1/00; B60L 3/04; B60W 20/00

(52) U.S. Cl. 307/10.1; 180/65.265

(57) ABSTRACT

The present invention provides a motor drive system for a hybrid vehicle and a method for controlling the same, which can prevent a counter electromotive force generated from a motor during turn-off of a main relay from being applied to non-powertrain components such as a DC converter and an electric air conditioner inverter, thus protecting the non-powertrain components and preventing the occurrence of failure.

### CROSS-REFERENCE TO RELATED APPLICATION

This application claims under 35 U.S.C. §119(a) the benefit of Korean Patent Application No. 10-2009-0119489 filed Dec. 4, 2009, the entire contents of which are incorporated herein by reference.

### BACKGROUND

(a) Technical Field

The present disclosure relates, generally, to a motor drive system for a hybrid vehicle and to a method for controlling the same. More particularly, the present invention relates to a motor drive system for a hybrid vehicle and a method for controlling the same, which can suitably prevent a counter electromotive force generated from a motor during turn-off of a main relay from being applied to non-powertrain components, such as a DC converter and an electric air conditioner inverter, thus protecting the non-powertrain components and preventing the occurrence of failure.

(b) Background Art

Hybrid vehicles employ an electric motor as an auxiliary power source as well as a gasoline engine to provide a reduction in exhaust gas and an improvement in fuel efficiency.

When the engine operates in an inefficient state, the electric motor is driven by the power of a battery to suitably increase the efficiency of a hybrid system (load leveling). Moreover, the battery is charged by regenerative braking during deceleration, in which the kinetic energy, which would be dissipated as frictional heat in a brake system, is converted into electrical energy by power generated by the motor, thereby improving the fuel efficiency.

Hybrid vehicles are divided into soft type hybrid vehicles and hard type hybrid vehicles based on whether or not the motor is connected and driven in a power transmission system.

An exemplary motor drive system for an existing hard type hybrid vehicle is shown in FIG. 4. As shown in FIG. 4, the motor drive system includes first and second motors M1 and M2 for driving the vehicle, first and second inverters 1 and 2 for driving the first and second motors M1 and M2, respectively, a DC battery B for outputting a DC voltage, a voltage converter 3 for stepping up the DC voltage from the DC battery B and supplying the stepped up voltage to the first and second inverters 1 and 2 or for stepping down the DC voltage from the first and second inverters 1 and 2 and supplying the stepped down voltage to the DC battery B, first and second main relays SR1 and SR2 connected between the DC battery B and the voltage converter 3, and a DC converter 4 and an electric air conditioner inverter 7 as electrical loads or power supply devices connected between the first and second main relays SR1 and SR2 and the voltage converter 3.

Preferably, the DC converter 4 is commonly called a power converter in which the energy flow is unidirectional or bidirectional, and reference numerals 5, 6 and 8 denote a 12V auxiliary battery, a 12V electrical load, and a DC-link capacitor, respectively.

In a motor drive system for a conventional hybrid vehicle with the above-described configuration, at the moment when the first and second main relays SR1 and SR2 are turned off, a high voltage (e.g., 600 V) is applied to the DC-link capacitor 8 by a counter electromotive force generated from the rotating motor, and this voltage is applied to non-powertrain components such as the DC converter 4 and the electric air conditioner inverter 7, which are suitably connected between the first and second main relays SR1 and SR2 and the voltage converter 3, through the voltage converter 3. Therefore, it is necessary to increase the maximum withstanding voltage of the non-powertrain components such as the DC converter 4 and the electric air conditioner inverter 7, which causes an increase in manufacturing cost for a hybrid system according to the high withstanding voltage and also causes deterioration in the efficiency of the system.

Further, in the event of a failure in the DC converter 4, the first and second main relays SR1 and SR2 are turned off immediately to prevent a secondary problem due to the DC power of the high voltage DC battery B. At this time, the power is not supplied to the first and second inverters 1 and 2, and thus the driving force of the first and second motors M1 and M2 for driving the hybrid vehicle is lost. Further, the first and second motors M1 and M2 including an electric generator are out of control during high speed operation of the engine, and thereby excessive rotation and counter electromotive force may be suitably applied to the electric generator. As a result, the possibility that the rotating part of the motor may be out of order and the inverter may be burnt out due to overvoltage is increased.

Furthermore, in examples where the vehicle is stopped after the first and second main relays SR1 and SR2 are turned off, since the driving force of the first and second motors M1 and M2 is lost, the vehicle cannot be started and cannot enter a limp-home mode for vehicle diagnosis. As a result, although the 12V power supply by the 12V auxiliary battery is available, the vehicle cannot be started, and it has to be towed away.

In addition, in an example where the DC battery B such as a high voltage battery is charged using the DC converter 4, the first and second main relays SR1 and SR2 are turned off, and the high voltage power is applied to the voltage converter 3 and the first and second inverters 1 and 2. Therefore, a controller performs a control operation to prevent malfunction of each IGBT of the voltage converter 3 and the first and second inverters 1 and 2. Accordingly, it is necessary to apply the power to an IGBT gate drive circuit to suitably maintain the IGBT in a turned-off state, which reduces the durability of the gate drive circuit. Further, unnecessary components should be operated at all times and, during long-term charge, the durability of the controller for preventing the IGBT malfunction may be suitably reduced and the possibility that the controller may malfunction is increased.

Accordingly, there remains a need in the art for new or improved motor drive systems for a hybrid vehicles.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a motor drive system for a hybrid vehicle and a method for controlling the same, in which non-powertrain components such as a DC converter and an electric air conditioner inverter are suitably connected between a DC battery and a main relay through an auxiliary relay so as to suitably prevent a counter electromotive force generated from a motor during turn-off of a main relay from being applied to the DC converter and the electric air conditioner inverter, thus protecting the non-powertrain components and suitably preventing the occurrence of failure. In preferred exemplary embodiments, even in the event of a failure in the DC converter, the motor drive system for a hybrid vehicle and the method for controlling the same of the present invention can quickly cope with the failure by suitably controlling the auxiliary relay.

In a preferred aspect, the present invention provides a motor drive system for a hybrid vehicle, the system including: first and second motors for suitably driving the vehicle; first and second inverters for suitably driving the first and second motors, respectively; a DC battery for suitably outputting a DC voltage; a voltage converter for suitably stepping up the DC voltage from the DC battery and suitably supplying the stepped up voltage to the first and second inverters or for suitably stepping down the DC voltage from the first and second inverters and suitably supplying the stepped down voltage to the DC battery; first and second main relays connected between the DC battery and the voltage converter; and a DC converter and an electric air conditioner inverter as non-powertrain components suitably connected between the DC battery and the first and main relays through first and second auxiliary relays.

In a preferred embodiment, the motor drive system of the present invention may further include a controller for suitably controlling the operation of the first and second main relays and that of the first and second auxiliary relays to cut off the electrical effect between the non-powertrain components such as the DC converter and the electric air conditioner inverter and powertrain components such as the first and second inverters.

In another preferred embodiment, the present invention provides a method for controlling a motor drive system for a hybrid vehicle, the method preferably including suitably determining whether there is a failure in a non-powertrain component such as a DC converter; turning off first and second auxiliary relays connected between a DC battery and first and second main relays if it is determined that there is a failure; suitably determining whether the vehicle is driven; maintaining the first and second main relays in a turned-on state such that first and second motors continue to run if it is determined that the vehicle is running in the event of a failure in the DC converter; and pressing an emergency button to turn on the first and second main relays such that the vehicle runs temporarily if it is suitably determined that the vehicle is turned off in the event of a failure in the DC converter.

In a preferred embodiment, the method of the present invention may further include suitably preventing an overvoltage due to a counter electromotive force of the motor from being applied to the DC converter at the moment when the first and second main relays are turned off even though the first and second auxiliary relays are turned on.

In another preferred embodiment, the method of the present invention may further include turning off the first and second main relays and, at the same time, turning on the first and second auxiliary relays such that the DC battery is charged by the DC converter if it is suitably determined that there is no failure in the DC converter as an electrical load or power supply device.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram of a motor drive system for a hybrid vehicle in accordance with an exemplary embodiment of the present invention.

FIGS. 2 and 3 are flowcharts illustrating a method for controlling a motor drive system for a hybrid vehicle in accordance with another exemplary embodiment of the present invention.

FIG. 4 is a schematic diagram of a motor drive system for a conventional hybrid system.

Reference numerals set forth in the Drawings includes reference to the following elements as further discussed below:

| | |
|---|---|
| 1: first inverter | 2: second inverter |
| 3: voltage converter | 4. DC converter |
| M1: first motor | M2: second motor |
| B: DC battery | SR1: first main relay |
| SR2: second main relay | SR3: first auxiliary relay |
| SR4: second auxiliary relay | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In a first aspect, the present invention features a motor drive system for a hybrid vehicle, the system comprising first and second motors for driving the vehicle, first and second inverters for driving the first and second motors, respectively, a DC battery for outputting a DC voltage, a voltage converter for stepping up the DC voltage from the DC battery and supplying the stepped up voltage to the first and second inverters or for stepping down the DC voltage from the first and second inverters and supplying the stepped down voltage to the DC battery, first and second main relays connected between the DC battery and the voltage converter, and a DC converter and an electric air conditioner inverter as non-powertrain components connected between the DC battery and the first and main relays through first and second auxiliary relays.

IN another aspect, the present invention features a method for controlling a motor drive system for a hybrid vehicle, the method comprising determining whether there is a failure in a non-powertrain component such as a DC converter turning off first and second auxiliary relays connected between a DC battery and first and second main relays if it is determined that there is a failure, determining whether the vehicle is driven, and maintaining the first and second main relays in a turned-on state such that first and second motors continue to run if it is determined that the vehicle is running in the event of a failure in the DC converter.

In one embodiment, the method further comprises pressing an emergency button to turn on the first and second main relays such that the vehicle runs temporarily if it is determined that the vehicle is turned off in the event of a failure in the DC converter.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

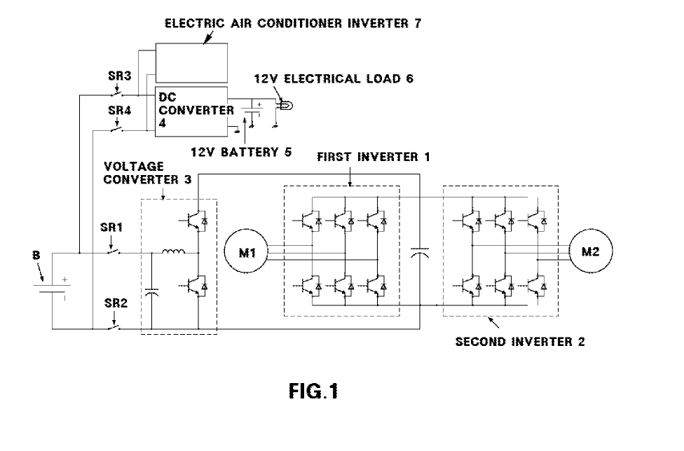

FIG. 1 is a schematic diagram of a motor drive system for a hybrid vehicle in accordance with an exemplary embodiment of the present invention.

Preferably, first and second inverters 1 and 2 as powertrain components are suitably connected to first and second motors M1 and M2 for driving the vehicle, respectively, through a DC battery B for outputting a DC voltage and a voltage converter 3.

In a further preferred embodiment, the voltage converter 3 steps up or down the DC voltage from the DC battery B and suitably supplies the DC voltage to the first and second inverters 1 and 2 or steps up or down the DC voltage from the first and second inverters 1 and 2 and supplies the DC voltage to the DC battery B.

Preferably, first and second main relays SR1 and SR2 for supplying or cutting off the power of the battery B are suitably disposed between the DC battery B and the voltage converter 3.

In further preferred embodiments, a DC converter 4 and an electric air conditioner inverter 7 as non-powertrain components are suitably connected between the DC battery B and the first and second main relays SR1 and SR2. Preferably, first and second auxiliary relays SR3 and SR4 are suitably mounted on a line from the DC battery B and the first and second main relays SR1 and SR2 to the DC converter 4 and the electric air conditioner inverter 7.

In further preferred embodiments, the operation of the first and second main relays SR1 and SR2 and that of the first and second auxiliary relays SR3 and SR4 are suitably controlled by a controller (not shown) to cut off the electrical effect between the non-powertrain components such as the DC converter 4 and the electric air conditioner inverter 7 and the powertrain components such as the first and second inverters 1 and 2.

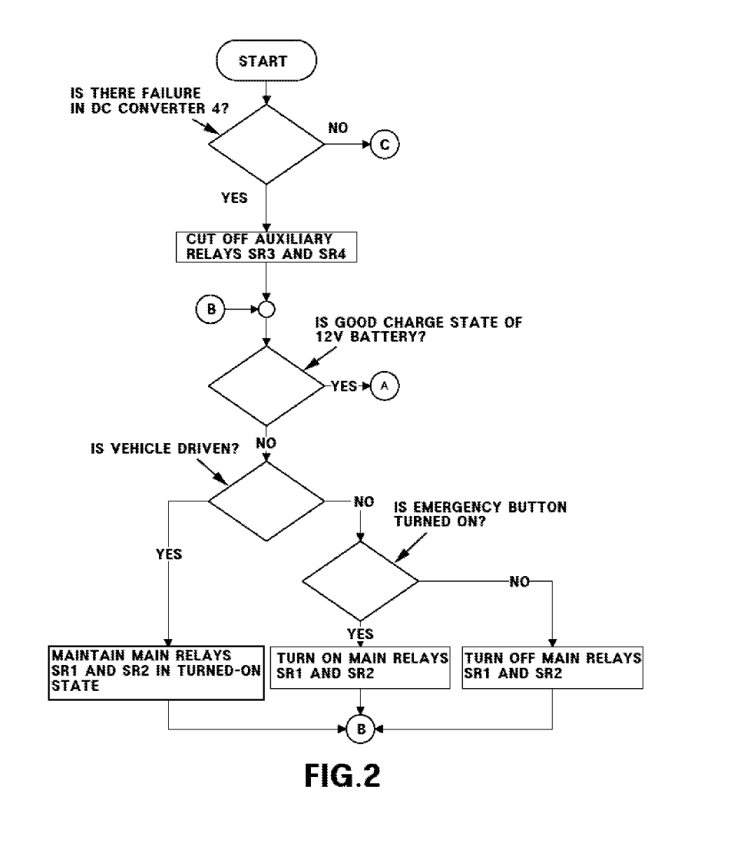

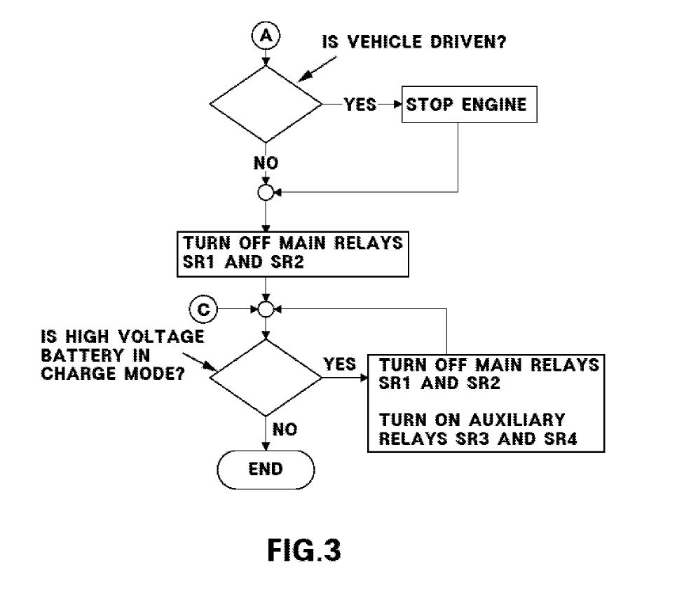

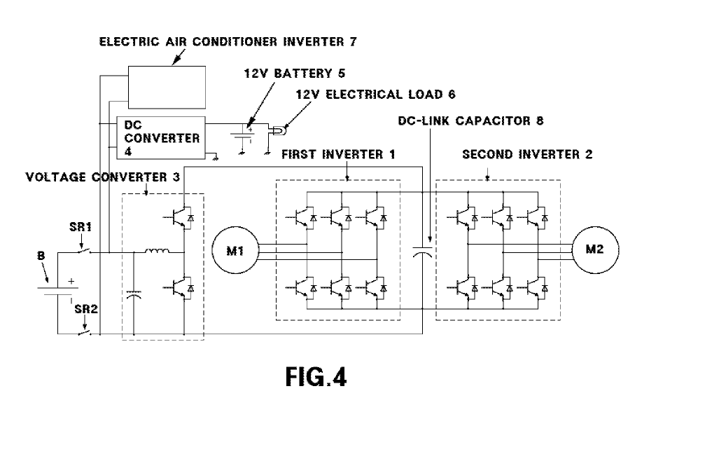

According to further preferred embodiments and as shown in FIGS. 2 and 3, FIGS. 2 and 3 are flowcharts illustrating a method for controlling a motor drive system for a hybrid vehicle.

In a preferred exemplary embodiment, in the event of a failure in the DC converter 4 as the non-powertrain component, which is represented as an electrical load or power supply device, the first and second auxiliary relays SR3 and SR4 connected between the DC battery B and the first and second main relays SR1 and SR2 are turned off.

Accordingly, even though the first and second main relays SR1 and SR2 are not turned off, an overvoltage due to the counter electromotive force of the motor is not suitably applied to the DC converter 4 and, as a result, it is possible to suitably protect the non-powertrain components such as the DC converter 4 and the electric air conditioner inverter 7 and suitably prevent the occurrence of failure.

In further preferred embodiments, at the moment when the first and second main relays SR1 and SR2 are turned off, the overvoltage due to the counter electromotive force of the motor may be suitably prevented from being applied to the DC converter 4 even though the first and second auxiliary relays SR4 and SR4 are turned on.

Accordingly, it is possible to suitably reduce the maximum withstanding voltage of the non-powertrain components such as the DC converter 4 and the electric air conditioner inverter 7 from 600 V to 300 V, for example, thereby reducing the manufacturing cost.

Preferably, when the vehicle is running in the event of a failure in the DC converter 4, the first and second auxiliary relays SR3 and SR4 are suitably turned off. However, the first and second main relays SR1 and SR2 are suitably maintained in the turned-on state such that the operation of the motors M1 and M2 by the power of the DC battery B can be continued.

In other further preferred embodiments, when the vehicle is suitably turned off in the event of a failure in the DC converter 4, an emergency button is pressed to turn on an emergency warning light and, at the same time, the first and second main relays SR1 and SR2 are turned on such that the vehicle can run temporarily, thus allowing a driver to reach the nearest service station.

In other further preferred embodiments, in the case where the DC converter 4 as the electrical load or power supply device normally operates, the first and second main relays SR1 and SR2 are suitably turned off and, at the same time, the first and second auxiliary relays SR3 and SR4 are suitably turned on such that the DC battery B can be charged by the DC converter 4.

Accordingly, it is possible to easily charge the DC battery B such as a high voltage battery using the DC converter 4. Further, since the first and second main relays SR1 and SR2 are suitably turned off during the charge of the battery, the high voltage power is not applied to the voltage converter 3 and the first and second inverters 1 and 2, and thereby it is possible to suitably improve the durability of the controller by eliminating the unnecessary logic of the controller to prevent malfunction of each IGBT of the voltage converter 3 and the first and second inverters 1 and 2.

As described herein, the present invention provides the following effects.

According to the present invention, the auxiliary relay is used to suitably prevent the counter electromotive force generated from the motor during turn-off of the main relay from being applied to the non-powertrain components such as the DC converter and the electric air conditioner inverter, thus suitably protecting the non-powertrain components and preventing the occurrence of failure.

Further, according to preferred embodiments of the present invention, since the overvoltage due to the counter electromotive force of the motor is not applied to the DC converter, it is possible to suitably reduce the maximum withstanding voltage of the DC converter and further reduce the capacity of the DC converter from 600 V to 300 V, for example, thereby suitably reducing the manufacturing cost.

According to other further preferred embodiments, even in the event of a failure in the DC converter, it is possible to suitably allow the driver to receive prompt after-sales service through the control of the main relay and auxiliary relay.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A motor drive system for a hybrid vehicle, the system comprising:
first and second motors for driving the vehicle;
first and second inverters for driving the first and second motors, respectively;
a DC battery for outputting a DC voltage;
a voltage converter for stepping up the DC voltage from the DC battery and supplying the stepped up voltage to the first and second inverters or for stepping down the DC voltage from the first and second inverters and supplying the stepped down voltage to the DC battery;
first and second main relays connected between the DC battery and the voltage converter; and
a DC converter and an electric air conditioner inverter as non-powertrain components connected between the DC battery and the first and main relays through first and second auxiliary relays.

2. The system of claim 1, further comprising a controller for controlling the operation of the first and second main relays and that of the first and second auxiliary relays to cut off the electrical effect between the non-powertrain components such as the DC converter and the electric air conditioner inverter and powertrain components such as the first and second inverters.

3. A method for controlling a motor drive system for a hybrid vehicle, the method comprising:
determining whether there is a failure in a non-powertrain component such as a DC converter;
turning off first and second auxiliary relays connected between a DC battery and first and second main relays if it is determined that there is a failure;
determining whether the vehicle is driven;
maintaining the first and second main relays in a turned-on state such that first and second motors continue to run if it is determined that the vehicle is running in the event of a failure in the DC converter; and
pressing an emergency button to turn on the first and second main relays such that the vehicle runs temporarily if it is determined that the vehicle is turned off in the event of a failure in the DC converter.

4. The method of claim 3, further comprising preventing an overvoltage due to a counter electromotive force of the motor from being applied to the DC converter at the moment when the first and second main relays are turned off even though the first and second auxiliary relays are turned on.

5. The method of claim 3, further comprising turning off the first and second main relays and, at the same time, turning on the first and second auxiliary relays such that the DC battery is charged by the DC converter if it is determined that there is no failure in the DC converter as an electrical load or power supply device.

6. A method for controlling a motor drive system for a hybrid vehicle, the method comprising:
determining whether there is a failure in a non-powertrain component such as a DC converter;
turning off first and second auxiliary relays connected between a DC battery and first and second main relays if it is determined that there is a failure;
determining whether the vehicle is driven; and
maintaining the first and second main relays in a turned-on state such that first and second motors continue to run if it is determined that the vehicle is running in the event of a failure in the DC converter.

7. The method for controlling a motor drive system for a hybrid vehicle of claim 6, further comprising pressing an emergency button to turn on the first and second main relays such that the vehicle runs temporarily if it is determined that the vehicle is turned off in the event of a failure in the DC converter.
